(19) United States
(12) Patent Application Publication
(10) Pub. No.: US 2026/0071553 A1
(43) Pub. Date: Mar. 12, 2026

(54) SURFACE HEAT EXCHANGER FOR A NACELLE OF A TURBINE ENGINE, AND TURBINE ENGINE NACELLE EQUIPPED WITH SUCH A HEAT EXCHANGER

(71) Applicant: SAFRAN NACELLES, Gonfreville-L'Orcher (FR)

(72) Inventors: Xavier Cazuc, Moissy-Cramayel (FR); Jean-Nicolas Pierre Bouchout, Moissy-Cramayel (FR); Marc AUBREE, Moissy-Cramayel (FR); Xavier Carcenac, Moissy-Cramayel (FR)

(21) Appl. No.: 19/101,074

(22) PCT Filed: Aug. 8, 2023
(86) PCT No.: PCT/FR2023/051257

§ 371 Date: Feb. 4, 2025

(30) Foreign Application Priority Data
Aug. 19, 2022 (FR) FR2208398

(51) Int. Cl. F01D 25/14; B64D 29/00; F01D 25/24

(52) U.S. Cl. CPC F01D 25/14; B64D 29/00; F01D 25/24; F05D 2260/213

(57) ABSTRACT

Surface heat exchanger, in particular for an aircraft nacelle, comprising a first metal sheet and a second metal sheet assembled together and at least three distribution channels disposed between the first metal sheet and the second metal sheet, the exchanger furthermore comprising an inlet hydraulic interface and an outlet hydraulic interface.

Each of the distribution channels is connected directly to the inlet hydraulic interface and to the outlet hydraulic interface, and in that the distribution channels are distributed over the whole of the circumference of the inlet hydraulic interface and/or of the outlet hydraulic interface.

### TECHNICAL FIELD OF THE INVENTION

The present invention relates to the field of heat exchangers, in particular fairings of an aircraft engine, called “nacelle”.

### PRIOR ART

Generally, an aircraft is propelled by one or more propulsion units each comprising an engine or turbojet engine housed in a tubular nacelle.

A nacelle generally comprises a tubular body comprising an upstream section comprising an air inlet upstream of the turbojet engine, a middle section configured to surround a fan of the turbojet engine and a downstream section configured to house thrust-reversal means and to surround the combustion chamber of the turbojet engine. The nacelle generally comprises an exhaust nozzle downstream of the downstream section and the outlet of which is located downstream of the turbojet engine.

Furthermore, the nacelle usually comprises an external structure and a fixed internal structure, referred to as “inner fixed structure”, with the acronym “IFS”. The fixed internal structure is concentric with the external structure, at the downstream section, and surrounds the core of the turbojet engine downstream of the fan.

These external and internal structures define an annular flow duct, referred to as the secondary duct, aimed at channeling a cold airflow, referred to as secondary, circulating at the outside of the turbojet engine.

The external structure includes an external fairing defining an external aerodynamic surface and an internal fairing defining an internal aerodynamic surface. The internal and external fairings are connected upstream by a leading-edge wall forming an air-inlet lip.

In general terms, the turbojet engine comprises a set of vanes rotated by a gas generator through a set of transmission means. The nacelle furthermore comprises a lubricant-distribution system in order to ensure good lubrication of these transmission means and to cool them. The lubricant is advantageously oil.

In order to cool the lubricant, the nacelle generally comprises a cooling system including at least one heat exchanger. The cooling system is configured to circulate a fluid, for example the lubricant or a cooling liquid that will cool the lubricant.

Among heat exchangers, air/lubricant exchangers are known, using air taken from the secondary duct (so-called cold flow) of the nacelle or from one of the first stages of the compressor. Taking and circulating air through the heat exchanger disturbs the flow of the airflow and causes additional pressure drops, referred to as drag, which is not desirable.

Heat exchangers are also known with fins secured to one of the walls of the nacelle delimiting the secondary duct. The fluid is cooled by the flow of the airflow in the secondary duct that circulates along the fins on the surface of the exchanger.

Such a solution also causes large aerodynamic losses.

This causes significant losses of fuel consumption.

Fluid-cooling systems comprising a structural surface exchanger are also known.

In the example illustrated on FIGS. 1 and 2, a structural surface exchanger 10 without fins comprising a first corrugated skin 11 and a so-called smooth second skin 12, assembled by welding or brazing or riveting.

Distribution channels 13 are formed by the assembly of the first skin 11 having corrugations on the so-called smooth or aerodynamic second skin 12, said skins 11, 12 then forming the double wall of the internal and/or external fairing.

Each distribution channel 13 is delimited by a corrugation on the first skin 11 and on the smooth second skin 12.

A fluid, for example a heat-transfer fluid or the lubricant, is intended to circulate in the channels 13 and air is intended to circulate in contact with the smooth second skin 12.

For this purpose, the smooth second skin 12 is intended to be in contact with an airflow. It makes it possible to maximize the flow of the airflow. Aerodynamic skin is spoken of.

The heat exchanger 10 furthermore comprises a fluid distributor 14 and fluid collector 15.

The fluid distributor 14 is a cavity formed in the corrugated first skin 11 for distributing the fluid at the inlet of the channels 13. The fluid distributor 14 is connected to an inlet hydraulic interface 16 of the exchanger.

The fluid collector 15 is a cavity formed in the corrugated first skin 11 for distributing the fluid at the outlet of the channels 13. The fluid collector 15 is connected to an outlet hydraulic interface 17 of the exchanger.

The heat exchanger 10 also comprises one or more stiffeners or reinforcement members 18 welded between the first and second skins 11, 12 and configured to provide the structural strength of said exchanger.

In this regard reference can be made to the document FR 3 094 657, which describes a method for manufacturing a structural surface exchanger for a nacelle.

However, the presence of a distributor and collector gives rise to formation risks because of the orientation of the distribution channels perpendicular to the orientation of the distributor and collector. The forming of connection radii of the distribution channels on the support surface, as well as connection radii of the distributor and collector on the support surface, are not optimized and give rise to high risks of tearing of the metal sheet.

The hydraulic pressure drops are also high because of the presence of stiffeners between the distributor and the support surface and between the collector and the support surface.

Moreover, the unsupported widths of the distributor, of the collector and of the points on the hydraulic interfaces generate peeling forces incompatible with current standards in the field of lap welding.

There is a need to optimize the systems for cooling a fluid, in particular the heat exchanges between a fluid and the air, while optimizing the structural strength of the heat exchanger.

### DESCRIPTION OF THE INVENTION

The aim of the present invention is therefore to overcome the aforementioned drawbacks.

The objective of the invention is to improve the heat exchanges between a fluid circulating in a heat exchanger and the air circulating outside said heat exchanger, while optimizing the structural strength of the heat exchanger.

The object of the invention is a turbine engine nacelle comprising an external structure and an internal structure delimiting an annular secondary flow duct, aimed at channeling a flow of cold air, referred to as secondary, circulating at the outside of the turbojet engine. Said nacelle comprises a housing for a turbine engine, delimiting with the internal structure an annular primary flow duct.

The nacelle comprises at least one surface heat exchanger secured either to the external structure, on the secondary-duct side or on the side external to said external structure, or on the internal structure, on the secondary-duct side or on the primary-duct side.

When the exchanger is secured to the internal surface of the internal fairing, the heat exchanger is secured in the secondary duct, so that the airflow circulating in the secondary duct is in contact with the second metal sheet.

When the exchanger is secured to the external surface of the internal structure of the nacelle, the heat exchanger is secured in the secondary duct, so that the airflow circulating in the secondary duct is in contact with the second metal sheet.

When the exchanger is secured to the external surface of the external structure of the nacelle, the heat exchanger is secured so that the external airflow is in contact with the second metal sheet.

Thus the heat exchanger can serve to cool a fluid from the secondary flow or from the external air.

When the heat exchanger is secured to the internal surface of the internal structure, i.e. in the fluid flow of the primary duct, it can serve to heat a fluid from the primary flow.

The surface heat exchanger comprises a first skin or metal sheet and a second skin or metal sheet assembled together and at least three distribution channels disposed between the first metal sheet and the second metal sheet.

The exchanger furthermore comprises an inlet hydraulic interface and an outlet hydraulic interface.

Each of the distribution channels is connected directly to the inlet hydraulic interface and to the outlet hydraulic interface, and the distribution channels are regularly distributed over the whole of the circumference of the inlet hydraulic interface and/or of the outlet hydraulic interface.

The absence of a distributor and collector improves the ease of forming the distribution channels, or even makes it possible to omit the operation of forming the first metal sheet, and reduces and homogenizes the hydraulic pressure drops, which improves the thermal performance.

In addition, the unsupported widths are reduced, which increases the structural-strength capacity of the heat exchanger.

“Directly” means a direct connection without intermediate element. In other words, there is no longer a collector and distributor located between the channels and respectively the inlet and outlet hydraulic interfaces.

This makes it possible to have a larger number of channels and to have a homogeneous distribution at the inlet or outlet whatever the number of channels. This also makes it possible to limit the pressure drops by directly supplying each channel from the inlet interface.

“Surface exchanger” means an exchanger without fins, a smooth exchanger, the wall or skin of which that defines the duct forms the heat-exchange surface.

Not having fins, or other forms intended to increase the contact surface between the flow and the exchanger, makes it possible not to have any obstacle to the airflow in the duct, and therefore to reduce the aerodynamic pressure drops.

“Metal sheet” means a flat steelmaking product, rolled either hot or cold, with a generally smooth surface or sometimes having projections. A metal sheet is therefore a metal material.

The distribution channels are configured to extend between the inlet hydraulic interface and the outlet hydraulic interface.

“Distributed over the whole of the circumference of the hydraulic interface” means that some channels are connected to one of the hydraulic interfaces by a first end extending in a direction opposite to the other one of the hydraulic interfaces.

The ends are extended by a main part, for example rectilinear, extending towards the other one of the hydraulic interfaces as far as a second end.

The second end can also extend in a direction opposite to one of the hydraulic interfaces.

For example, the channels are connected to the inlet hydraulic interface by an inlet end and to the outlet hydraulic interface by an outlet end.

The inlet end is, for example, connected to the outlet end by a main part.

An inlet end of at least one channel extends in a direction opposite to the outlet hydraulic interface and an outlet end of at least one channel extends in a direction opposite to the inlet hydraulic interface.

For example, the inlet and outlet hydraulic interfaces have a circular-shaped cross-section.

For example, the inlet and outlet hydraulic interfaces each comprise an outlet orifice extending in a plane perpendicular to the extension planes of the metal sheets.

Advantageously, the thickness of each distribution channel is constant over the entire length of the corresponding channel.

For example, the distribution channels have cross-sections identical to each other.

In a variant, cross-sections different between each of the channels could be provided. For example, provision could be made for the longest distribution channels to have a larger cross-section order to balance the flow rates between said distribution channels.

According to one embodiment, each of the first and second metal sheets is flat.

In a variant, each of the first and second metal sheets is curved to provide aerodynamic continuity with the rest of the nacelle.

Advantageously, the exchanger comprises a plurality of struts or spacing members disposed between the first metal sheet and the second metal sheet, two adjacent spacing members delimiting a distribution channel.

For example, the first metal sheet and the second metal sheet are assembled together by an assembly zone, for example welding or brazing, at the spacing members, said assembly zone extending from the first metal sheet to the second metal sheet.

According to a variant, the assembly zone can pass through the corresponding spacing member.

For example, the spacing members each have a thickness of between 2 mm and 4 mm, for example equal to 3 mm.

In a variant, the spacing members can form part of the second metal sheet, by machining the inter-channel zones and the channels directly on said second metal sheet. In this variant, the thickness of the assembly zone is reduced and extends from the first metal sheet as far as the adjacent part of the second metal sheet.

For example, the cross-section of each of the distribution channels is in the form of a quadrilateral, such as for example a trapezium, a square, a rectangle, etc.

According to one embodiment, the first metal sheet comprises a plurality of corrugations, the distribution channels each being delimited by a corrugation on the corrugated first metal sheet and the second metal sheet.

For example, each distribution channel has a cross-section in a semicircle.

In general, the first metal sheet has a thickness of between 1 and 2 mm and the second metal sheet has a thickness of between 0.6 and 2 mm.

The first metal sheet and/or the second metal sheet is made from aluminum or alloy including aluminum. This improves the lightness and formability of the metal sheets and the heat exchanges.

Advantageously, the exchanger comprises an axis of symmetry passing through the inlet hydraulic interface and the outlet hydraulic interface, the distribution channels being disposed symmetrically with respect to said axis of symmetry.

### BRIEF DESCRIPTION OF THE DRAWINGS

Other aims, features and advantages of the invention will appear upon reading the following description, given only as a non-limiting example, and made with reference to the appended drawings wherein:

FIG. 1 is a schematic view of a structural surface exchanger according to the prior art;

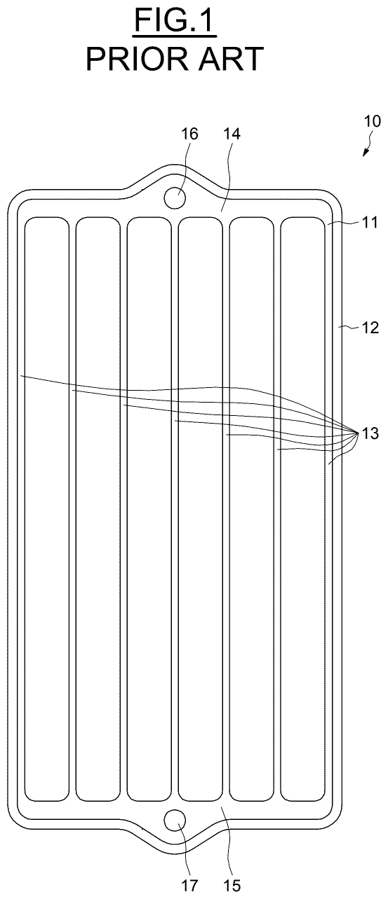

FIG. 2 is a detail view in partial cross-section of the exchanger of FIG. 1;

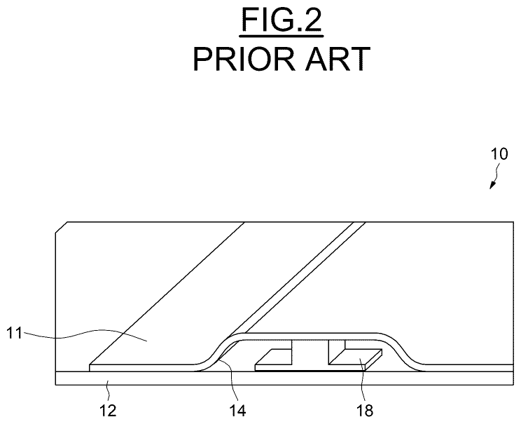

FIG. 3 is a schematic view of a surface heat exchanger according to one embodiment of the invention;

FIG. 4 is a detail view in partial cross-section of the exchanger of FIG. 3;

FIG. 5 is a schematic view of a surface heat exchanger according to a second embodiment of the invention;

FIG. 6 is a detail view in partial cross-section of the exchanger of FIG. 5;

FIG. 7 is a schematic view of a surface heat exchanger according to a third embodiment of the invention;

FIG. 8 is a schematic view of a surface heat exchanger according to a fourth embodiment of the invention;

FIG. 9 is a schematic view of a surface heat exchanger according to a fifth embodiment of the invention;

FIG. 10 is a schematic view of a surface heat exchanger according to a sixth embodiment of the invention; and

FIG. 11 is a schematic view of a turbine engine comprising an aircraft nacelle equipped with a heat exchanger according to one of the embodiments of the invention.

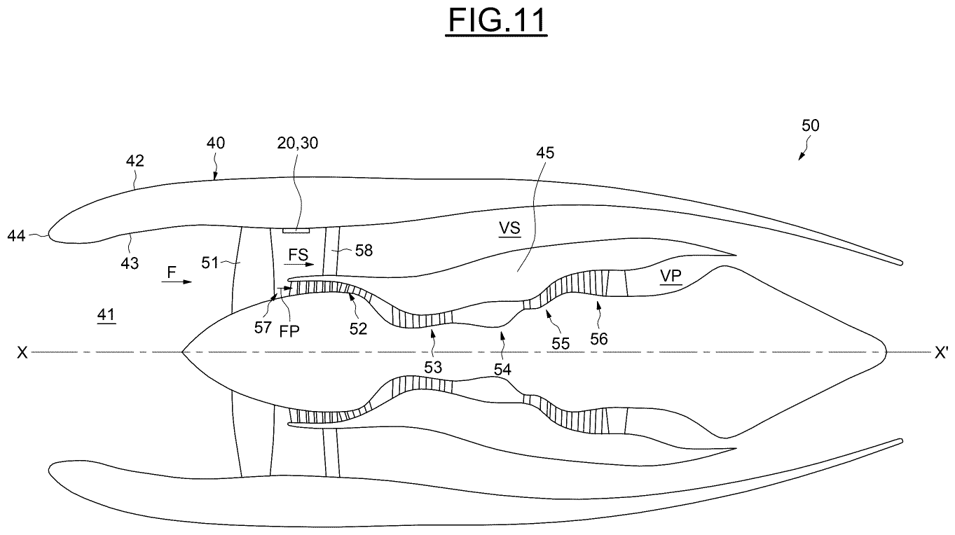

### DETAILED DESCRIPTION OF AT LEAST ONE EMBODIMENT

In the following description, the terms “upstream” and “downstream” are defined with respect to the direction of air circulation in the turbine engine. The terms “internal” and “external” are defined with respect to the longitudinal axis of the turbine engine, the term internal defining an element closer to said axis than an external element.

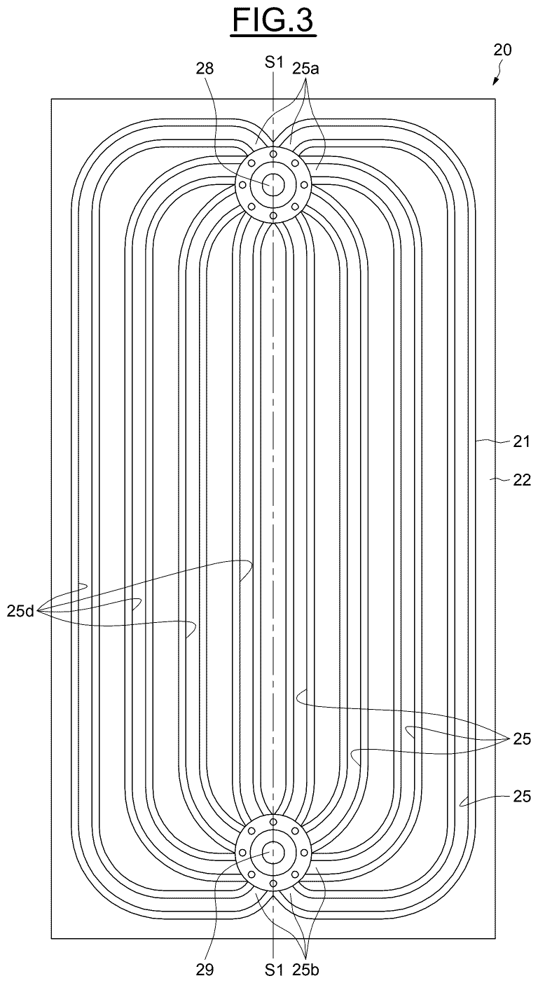

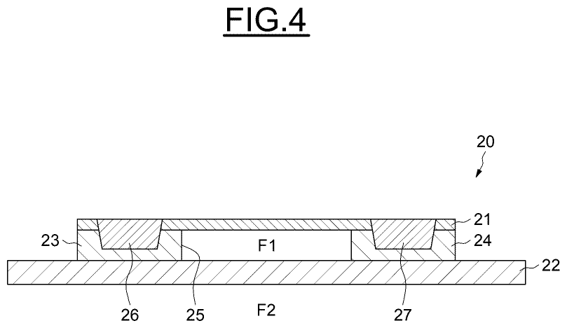

With reference to the example illustrated on FIGS. 3 and 4, a heat exchanger 20 comprises a first skin or metal sheet 21 and a second skin or metal sheet 22 assembled one on the other by means of struts or spacing members 23, 24 visible on FIG. 4.

The struts 23, 24 and the second skin 22 form a single piece.

Each of the first and second skins 21, 22 is here flat. In a variant, provision can be made for the first and second skins 21, 22 to be curved.

The exchanger 20 comprises a plurality of distribution channels 25 each delimited laterally between two adjacent struts 23, 24 and vertically between the first and second skin 21, 22.

In no way limitatively, the cross-section of each of the distribution channels 25 is here in the form of a rectangle. In a variant, provision can be made for the cross-section to be in the general form of any quadrilateral, such as for example a trapezium, a square, etc. In general terms, the cross-section of each of the distribution channels 25 can have any form.

As illustrated, the distribution channels 25 have cross-sections identical to each other.

In a variant, cross-sections different between each of the channels could be provided.

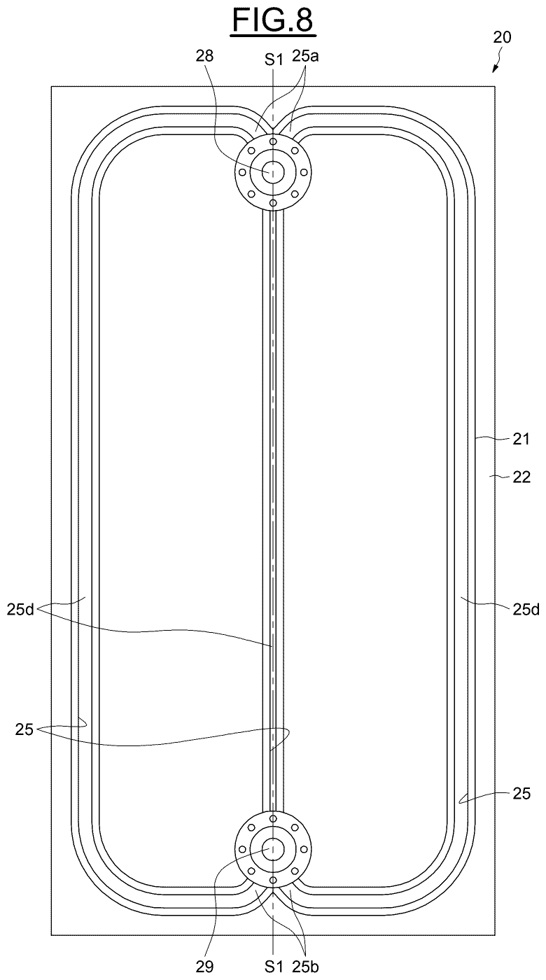

For example, provision could be made for the longest distribution channels to have a larger cross-section order to balance the flow rates between said distribution channels, as can be seen in the example in FIG. 8.

The distribution channels 25 are respectively connected directly to an inlet hydraulic interface 28 and to an outlet hydraulic interface 29.

In other words, there is no longer a collector and distributor located between the channels 25 and respectively the inlet 28 and outlet 29 hydraulic interfaces.

As illustrated on FIG. 3, the inlet ends 25a of the distribution channels 25 are distributed uniformly, i.e. regularly distributed, over the whole of the circumference of the inlet hydraulic interface 28, and the outlet ends 25b of the distribution channels 25 are distributed uniformly over the whole of the circumference of the outlet hydraulic interface 29.

Preferably, the distribution channels 25 can be regularly distributed circumferentially between them around the inlet hydraulic interface 28 and/or the outlet hydraulic interface 29. In other words, the “center” of each distribution 25, at the connection with the inlet hydraulic interface 28 and/or the outlet hydraulic interface 29, is regularly circumferentially spaced apart from the “center” of an adjacent distribution channel.

In general terms, the distribution channels 25 are distributed over the whole of the circumference of the inlet hydraulic interface 28 and/or of the outlet hydraulic interface 29.

“Distributed over the whole of the circumference” means that an inlet end 25a of at least one channel 25 extends in a direction opposite to the outlet hydraulic interface 29 and that an outlet end 25b and at least one channel 25 extends in a direction opposite to the inlet hydraulic interface 28.

The inlet ends 25a of the channels 25 and the outlet ends 25b of the channels 25 have a curved shape.

The concavity of the inlet ends 25a and of the outlet ends 25b of the channels 25 is directed towards the center of the exchanger 20.

The inlet ends 25a and the outlet ends 25b are connected together by a main part 25d, here rectilinear.

The first and second skins 21, 22 are assembled by an assembly zone 26, 27, for example a welding or brazing zone 26, 27 at the struts 23, 24. Said assembly zone 26, 27 extends from the first skin 21 as far as the second skin 22, passing through the corresponding strut 23, 24.

In a variant, the spacing members can form part of the second metal sheet, by machining the inter-channel zones and the channels directly on said second metal sheet. In this variant, the thickness of the assembly zone is reduced and extends from the first metal sheet as far as the adjacent part of the second metal sheet.

As illustrated on FIG. 3, and in no way limitatively, the exchanger 20 comprises eight distribution channels 25.

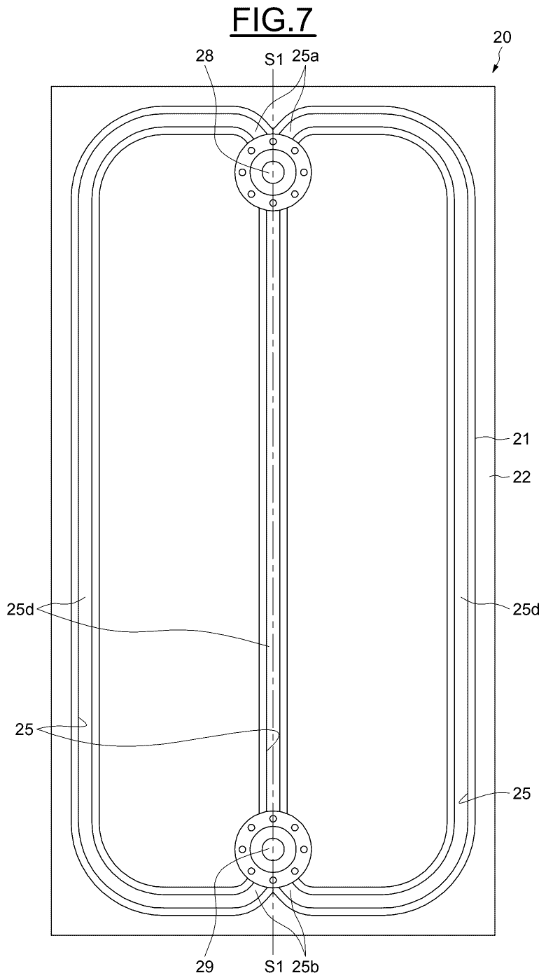

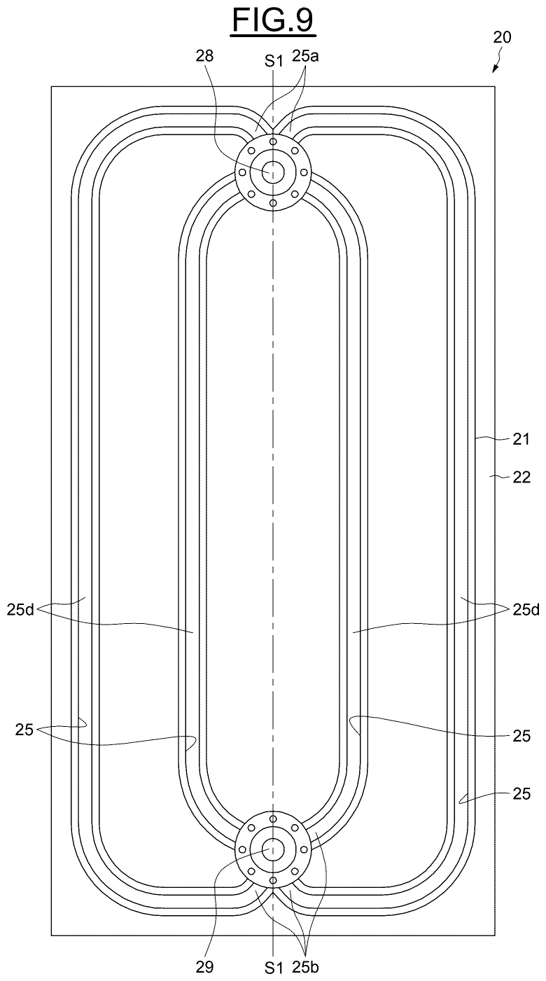

In a variant, the heat exchanger 20 could comprise a different number of distribution channels 25, example greater than or equal to three, as illustrated on FIG. 7, or greater than or equal to four, as illustrated in the example in FIG. 9, wherein the same elements bear the same references.

In the embodiments illustrated on FIGS. 3, 5, 7 to 9, the exchanger 20, 30 comprises an axis of symmetry S1-S1 passing through the inlet interface 28 and the outlet interface 29. The distribution channels 25, 35 are disposed symmetrically with respect to said axis of symmetry S1, S1.

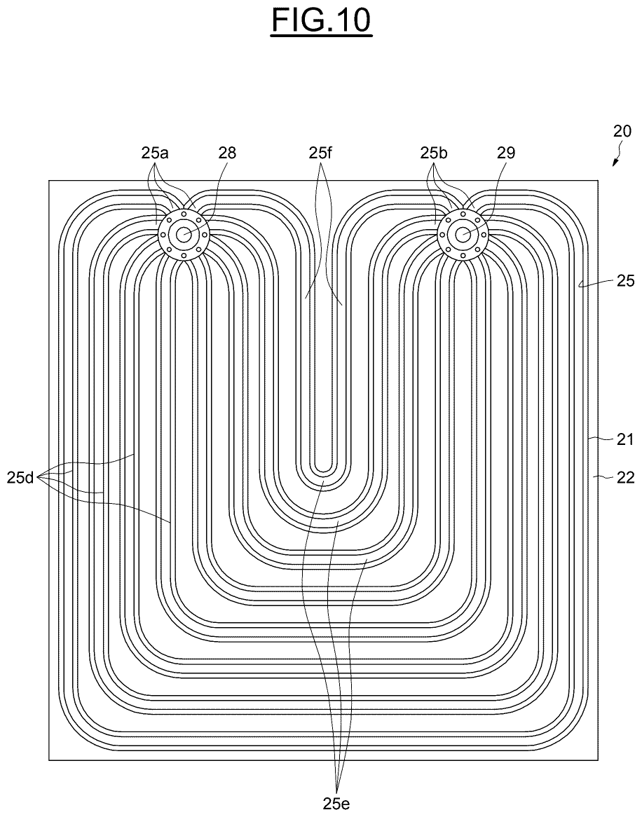

In the example illustrated on FIG. 10, the concavity of the inlet ends 25a and of the outlet ends 25b of the channels 25 is directed towards the center of the exchanger 20. The inlet ends 25a and the outlet ends 25b are connected together by a main part comprising a rectilinear first portion 25d, a portion 25e having a concavity directed towards the center of the exchanger 20, and a rectilinear second portion 25f.

The struts 23, 24 each have a thickness of between 2 mm and 4 mm, for example equal to 3 mm.

The exchanger 20 is a surface heat exchanger between a first fluid F1 and air F2. The fluid F1 is intended to circulate in the channels 25 and the air is intended to circulate in contact with the smooth second skin 22.

By virtue of the presence of struts between the first and second skins 21, 22, the step of forming the first skin is eliminated.

In the example illustrated on FIG. 3, the hydraulic interfaces 28, 29 are aligned on a longitudinal axis and the distribution channels 25 extend between said hydraulic interfaces 28, 29.

In a variant, provision could be made for the hydraulic interfaces 28, 29 to be aligned on another axis, for example a transverse axis, as illustrated in the example in FIG. 10, in which the same elements bear the same references.

In general terms, the invention is not limited to the form of the distribution channels, which are configured to extend between the inlet hydraulic interface 28 and the outlet hydraulic interface 29.

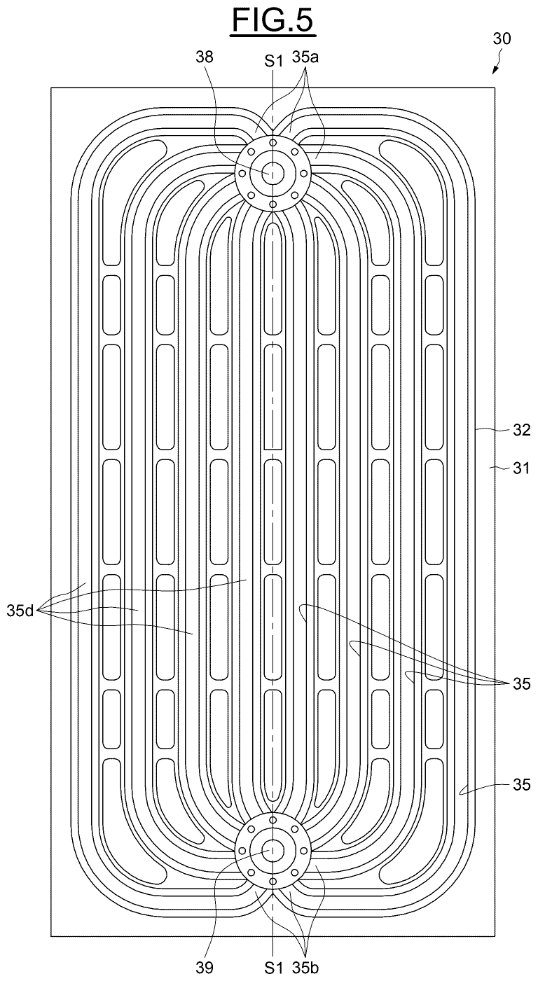

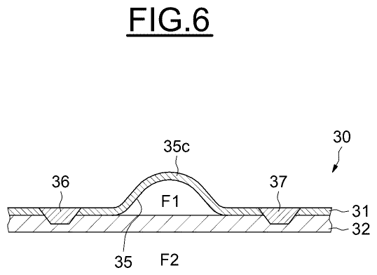

FIGS. 5 and 6 illustrate another embodiment that differs from the embodiment illustrated on FIGS. 3 and 4 solely by the fact that the first skin or metal sheet comprises a plurality of corrugations produced by forming said first skin.

As illustrated on FIGS. 5 and 6, a heat exchanger 30 comprises a first skin or metal sheet 31 and a second skin or metal sheet 32.

The first skin 31 comprises a plurality of corrugations 35c and the second skin 32 is here flat.

The exchanger 30 comprises a plurality of distribution channels 35 each delimited by a corrugation 35c of the corrugated first skin 31 and the second skin 32 is said to be smooth.

The exchanger 30 is a heat exchanger between a first fluid F1 and air F2. The fluid F1 is intended to circulate in the channels 35 and the air is intended to circulate in contact with the smooth second skin 32.

Each distribution channel 35 has a cross-section in a semicircle.

As illustrated, the distribution channels 25 have cross-sections with a size identical to each other.

In a variant, cross-sections with different sizes between each of the channels could be provided.

For example, provision could be made for the longest distribution channels to have a larger cross-section order to balance the flow rates between said distribution channels.

The distribution channels 25 are respectively connected directly to an inlet hydraulic interface 38 and to an outlet hydraulic interface 39.

In other words, there is no longer a collector and distributor located between the channels 35 and respectively the inlet 38 and outlet 39 hydraulic interfaces.

As illustrated on FIG. 5, the inlet ends 35a of the distribution channels 35 are distributed uniformly, i.e. regularly distributed, over the whole of the circumference of the inlet hydraulic interface 38, and the outlet ends 35b of the distribution channels 35 are distributed uniformly over the whole of the circumference of the outlet hydraulic interface 39.

“Distributed over the whole of the circumference” means that an inlet end 35a of at least one channel 35 extends in a direction opposite to the outlet hydraulic interface 39 and that an outlet end 35b and at least one channel 35 extends in a direction opposite to the inlet hydraulic interface 38.

The inlet ends 35a of the channels 35 and the outlet ends 35b of the channels 35 have a curved shape.

The concavity of the inlet ends 35a and of the outlet ends 35b of the channels 35 is directed towards the center of the exchanger 30. The inlet ends 35a and the outlet ends 35b are connected together by a main part 35d, here rectilinear.

In a variant, a more complex form could be provided, as visible on FIG. 10.

The first and second skins 31, 32 are assembled by a welding or brazing zone 36, 37 on either side of the corrugation 35c of the corrugated skin 31. Said welding or brazing zone 36, 37 extends from the first skin 31 as far as the second skin 32.

In general, the first skin 21, 31 has a thickness of between 1 and 2 mm and the second skin 22, 32 has a thickness of between 0.6 and 2 mm.

The first skin and/or the second skin 21, 31; 22, 32 is made from aluminum or alloy including aluminum. This improves the lightness, the heat exchanges and the formability of the skins.

The exchanger is, for example, fluidtight up to 10 bar.

The heat exchangers 20, 30 described above are advantageously intended to equip a nacelle 40 of a turbine engine 50 or aircraft engine visible on FIG. 9.

FIG. 9 shows highly schematically an axial section of a turbine engine 50, of longitudinal general axis X-X′, for example of the twin-spool bypass turbojet engine type, comprising a fan 51, coupled to a gas turbine engine including a low-pressure compressor 52, a high-pressure compressor 53, an annular combustion chamber 54, a high-pressure turbine 55 and a low-pressure turbine 56.

The rotors of the high-pressure compressor and of the high-pressure turbine are connected by a high-pressure (HP) shaft (not shown) and form therewith a high-pressure spool. The rotors of the low-pressure compressor and of the low-pressure turbine are connected by a low-pressure (LP) shaft (not shown) and form therewith a low-pressure spool. The HP and LP shafts extend along a longitudinal axis X-X′ of the turbine engine 50.

The fan shaft is rotationally connected to the LP shaft directly or indirectly.

It should be noted that the invention is not limited to such a turbine engine structure and could apply to a turbine engine with a different structure, for example to a turbine engine of the bypass turbojet engine type, in which the low-pressure compressor serves as a fan.

The nacelle 40 of the turbine engine comprises a housing 41 for the turbine engine 50 and has a tubular structure comprising an external fairing 42 defining an external aerodynamic surface and an internal fairing 43 defining an internal aerodynamic surface for flow through the turbine engine 50 and in particular the fan 51.

The internal and external fairings 42, 43 are connected upstream by an air-inlet lip 44 forming a leading edge of the nacelle 40.

The external and internal fairings 42, 43 delimit an external structure usually comprising a fixed part and a movable part (not shown), such as for example thrust-reversal means.

The nacelle 40 furthermore comprises a fixed internal structure 45, referred to as “inner fixed structure”, with the acronym “IFS”. The fixed internal structure 45 is concentric with the external structure, at a downstream section, and surrounds the core of the turbojet engine 50 downstream of the fan 51.

These external and internal structures define an annular flow duct, referred to as the secondary duct VS, aimed at channeling a cold airflow, referred to as secondary, circulating outside the turbojet engine 50.

Downstream of the fan 51, the main airflow F is separated by the fixed internal structure 45 of the nacelle, here serving as a separation member, into a primary airflow FP and a secondary airflow FS.

The primary airflow FP travels through an internal passage or primary duct VP while entering the low-pressure compressor 52, for example at inlet guide vanes 57, with the acronym IGV.

The secondary airflow FS travels through an external annular passage or secondary duct VS, for example in the direction of outlet guide vanes 58, with the acronym OGV, and then to the outlet of the turbine engine.

The nacelle 40 is equipped with a heat exchanger 20, 30, here secured to the internal surface of the internal fairing 43. Thus the heat exchanger 20, 30 is secured in the secondary duct VS, so that the airflow circulating in the secondary duct VS is in contact with the second skin 22, 32 of the heat exchanger 20, 30.

In a variant, provision could be made for the heat exchanger 20, 30 to be secured here to the external surface of the internal structure 45 of the nacelle 40.

According to another variant, the heat exchanger 20, 30 can be secured to the external surface of the external fairing 42 of the nacelle 40. Thus the heat exchanger 20, 30 can serve to cool a fluid from the secondary flow FS or from the external air.

According to yet another variant, the heat exchanger 20, 30 could be secured to the internal surface of the internal structure 45, i.e. in the fluid flow of the primary duct VP.

Thus the heat exchanger 20, 30 can serve to heat a fluid from the primary flow FP.

The cooling air circulates through the exchanger, in particular the second so-called smooth skin 22, 32, where it recovers part of the thermal energy of the heat-transfer fluid.

By means of the invention, the heat exchanges between a fluid circulating in the heat exchanger and the air circulating outside said heat exchanger are optimized, while improving the structural strength of the heat exchanger and reducing the aerodynamic pressure drops.

Moreover, the absence of a distributor and collector improves the ease of forming the distribution channels, or even makes it possible to omit this forming operation and reduces and homogenizes the hydraulic pressure drops.

1. Turbine-engine nacelle comprising an external structure and an internal structure delimiting an annular secondary-flow duct, said nacelle comprising a housing for a turbine engine, delimiting with the internal structure an annular primary-flow duct, the nacelle comprising at least one surface heat exchanger secured either to the external structure, on the secondary-duct side or on the side external to said external structure, or to the internal structure, on the secondary-duct side or on the side of the primary duct, the surface heat exchanger comprising a first metal sheet and a second metal sheet connected together and at least three distribution channels disposed between the first metal sheet and the second metal sheet, the exchanger furthermore comprising an inlet hydraulic interface and an outlet hydraulic interface, each of the distribution channels being connected directly to the inlet hydraulic interface and to the outlet hydraulic interface, wherein the distribution channels are regularly distributed over the whole of the circumference of the inlet hydraulic interface and/or of the outlet hydraulic interface, and wherein the distribution channels each comprise an inlet end and an outlet end each having a curved form.

2. Nacelle according to claim 1, wherein the distribution channels have cross-sections identical to each other.

3. Nacelle according to claim 1, wherein the distribution channels have cross-sections different from each other.

4. Nacelle according to claim 1, comprising a plurality of spacing members disposed between the first metal sheet and the second metal sheet, two adjacent spacing members delimiting a distribution channel.

5. Nacelle according to claim 4, wherein the first metal sheet and the second metal sheet are assembled together by an assembly zone at the spacing, said assembly zone extending from the first metal sheet to the second metal sheet.

6. Nacelle according to claim 1, wherein the first metal sheet comprises a plurality of corrugations, the distribution channels each being delimited by a corrugation on the corrugated first metal sheet and the second metal sheet.

7. Nacelle according to claim 6, wherein each distribution channel has a cross-section in a semicircle.

8. Nacelle according to claim 1, wherein the exchanger comprises an axis of symmetry passing through the inlet hydraulic interface and the outlet hydraulic interface, the distribution channels being disposed symmetrically with respect to said axis of symmetry.

9. Nacelle according to claim 1, wherein the inlet and outlet hydraulic interfaces have a circular-shaped cross-section and each comprise an outlet orifice extending in a plane perpendicular to the extension planes of the metal sheets.

10. Nacelle according to claim 1, wherein the thickness of each distribution channel is constant over the entire length of the corresponding channel.
